(19) United States
(12) Patent Application Publication
(10) Pub. No.: US 2010/0166014 A1
(43) Pub. Date: Jul. 1, 2010

(54) APPARATUS AND METHOD FOR RECOMBINING MULTI-PROTOCOL ENCAPSULATION (MPE) PACKETS

(76) Inventors: Won-Ho Kim, Chungcheongnam-do (KR); Nam-Kyung Lee, Daejon (KR); Yun-Jeong Song, Daejon (KR)

Correspondence Address: LADAS & PARRY LLP, 224 SOUTH MICHIGAN AVENUE, SUITE 1600, CHICAGO, IL, 60604, US

(21) Appl. No.: 12/095,519

(22) PCT Filed: Nov. 27, 2006
(86) PCT No.: PCT/KR2006/005020

§ 371 Date: May 30, 2008

(30) Foreign Application Priority Data
Dec. 1, 2005 (KR) 10-2005-0116130
May 29, 2006 (KR) 10-2006-0048233

(51) Int. Cl. H04J 3/24

(52) U.S. Cl. 370/474

(57) ABSTRACT

Provided is an apparatus and method for recombining multi-protocol encapsulation (MPE) packets. The apparatus includes the steps of: a buffer for buffering transport stream (TS) packets; a first memory for temporally storing residue data; a second memory for storing a residue data existence flag and length information of data; a MPE recombination processor for analyzing header information, storing the length information of an MPE packet, creating an asynchronous transfer mode (ATM) cell header, reading packet data, creating and outputting an ATM adaptive layer 0 (AALO-ATM) cell and the read packet data, updating the length information of the data, reading the residue data, reading insufficient data and creating an AALO-ATM cell; and a segmentation and reassemble (SAR) processor for buffering the AALO-ATM cell, and transporting the AALO-ATM cell.

### TECHNICAL FIELD

The present invention relates to an apparatus and method for recombining multi-protocol encapsulation (MPE) packets; and, more particularly, to an apparatus and method for rapidly recombining a maximum of 8192 MPE packets in parallel which are transported in the form of Moving Picture Experts Group 2 (MPEG2) transport stream (TS) packets from a terminal to a central station through a return link to provide a broadband multimedia service in a bi-directional satellite multimedia system.

### BACKGROUND ART

In a conventional satellite multimedia system, multimedia data transported from a terminal of a return link to a central station is formed of asynchronous transfer mode (ATM) adaptive layer 5 (AAL5) packets. The terminal partitions an ATM-AAL5 packet into 53-byte ATM cells and transports the ATM cells to the central station through a satellite link. The central station recombines the transported ATM cells into the ATM-AAL5 packet and eventually extracts the multimedia data.

Recently, increasing multimedia data services provide data in the format of a Moving Picture Experts Group (MPEG)-based multi-protocol encapsulation (MPE) packet. Accordingly, a method for transporting the multimedia data through the return link of a bi-directional satellite multimedia system is required.

### DISCLOSURE OF INVENTION

### Technical Problem

It is, therefore, an object of the present invention to provide an apparatus and method for rapidly recombining many multi-protocol encapsulation (MPE) packets in parallel which are transported based on Moving Picture Experts Group 2 (MPEG2) to extend a function of a system and provide diverse multimedia data services.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### Technical Solution

In accordance with one aspect of the present invention, there is provided an apparatus recombining for multi-protocol encapsulation (MPE) packets, the apparatus including the steps of: a buffer for buffering inputted transport stream (TS) packets; a first memory for temporally storing residue data whose size is too small to form a cell buffered in the buffer; a second memory for storing a residue data existence flag and length information of data currently buffered in the buffer; a MPE recombination processor for analyzing header information of a buffered TS packet, storing the length information of an MPE packet in the second memory, creating an asynchronous transfer mode (ATM) cell header, reading packet data from the buffer, creating and outputting an ATM adaptive layer 0 (AAL0-ATM) cell as the created ATM cell header and the read packet data, updating the length information of the data buffered in the buffer and stored in the second memory by reducing the length information by a length of the data read in the buffer, reading the residue data stored in the first memory in case that the residue data existence flag is set up with respect to a packet having the same packet identifier (PID), reading insufficient data in the buffer and creating an AAL0-ATM cell; and a segmentation and reassemble (SAR) processor for buffering the AAL0-ATM cell transported from the MPE recombination processor based on each PID, and transporting the AAL0-ATM cell to a host Central Processing Unit (CPU).

When a memory address is allotted identically with the PID, the first memory stores the residue data in a memory address corresponding to the packet identifier.

When the memory address is allotted by including the PID, the second memory stores the residue data existence flag, length information of the data currently buffered in the buffer and length information of the residue data stored in the first memory correspondingly to the packet identifier.

The MPE recombination processor decodes a header of the TS packet buffered in the buffer, checks the PID of the buffered packet and a payload unit start indicator (PUSI), and stores the length information of the packet in a memory address corresponding to the packet identifier of the second memory by the PUSI in case of a first packet.

In accordance with another aspect of the present invention, there is provided a method for recombining MPE packets, the method including the steps of: a) when at least one TS packet is buffered, reading header information of the buffered TS packet; b) checking a PID and a PUSI in the header information, and storing data length information of the currently buffered TS packet when a first packet is identified by the PUSI; c) creating an ATM cell header and checking whether residue data corresponding to the PID exist; d) when the residue data do not exist in the step c), reading data of the buffered TS packet, creating an AAL0-ATM cell by being integrated with the created header, transporting the AAL0-ATM cell to a segmentation and reassemble (SAR) chip and simultaneously updating data length information of the currently buffered TS packet; e) when the residue data exist in the step c), reading the pre-stored residue data correspondingly to the PID, reading the data of the buffered TS packet as much as data insufficient for organizing a cell, creating the AAL0-ATM cell by being integrated with the created header, transporting the AAL0-ATM cell to the SAR chip and simultaneously updating the data length information of the currently buffered TS packet; and f) when the data length information of the currently buffered TS packet has a value which is not proper to organize a cell, setting up the residue data existence flag correspondingly to the PID and temporally storing the residue data length information and the buffered residue data at the same time.

### Advantageous Effects

The present invention can provide a Moving Picture Experts Group (MPEG)-based broadband multimedia service with a data service of an asynchronous transfer mode (ATM) adaptive layer 5 (AAL5) form by reducing load applied to a host Central Processing Unit (CPU) of a central station and rapidly recombining multi-protocol encapsulation (MPE) data packets at the same time, which are transported based on Moving Picture Experts Group 2 (MPEG2) from a terminal of a bi-directional satellite multimedia system to the central station. Also, since the present invention is formed of only a complete digital circuit, it can be realized as a field-programmable gate array (FPGA) or an application specific integrated circuit (ASIC).

### BRIEF DESCRIPTION OF THE DRAWINGS

The above and other objects and features of the present invention will become apparent from the following description of the preferred embodiments given in conjunction with the accompanying drawings, in which:

FIG. 1 shows a structure of a general multi-protocol encapsulation (MPE) packet;

FIG. 2 is a block diagram showing an apparatus for recombining MPE packets obtained by dividing data and transported in the form of Moving Picture Experts Group 2 (MPEG-2) Transport Stream (TS) packets in accordance with an embodiment of the present invention;

FIG. 3 shows a memory structure of an index Random Access Memory (RAM) in accordance with an embodiment of the present invention;

FIG. 4 shows a memory structure of the data RAM in accordance with the embodiment of the present invention;

FIG. 5 shows a structure of a 53-byte asynchronous transfer mode (ATM) adaptive layer 0 (AAL0-ATM) cell;

FIG. 6 is a flowchart describing a method for recombining MPE packets obtained by dividing data and transported in the form of MPEG2 TS packets in accordance with an embodiment of the present invention; and

FIG. 7 shows state shift of an MPE recombination processor in accordance with an embodiment of the present invention.

### BEST MODE FOR CARRYING OUT THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on prior art may obscure the points of the present invention, the detailed description will not be provided herein. The preferred embodiments of the present invention will be described in detail hereinafter with reference to the attached drawings.

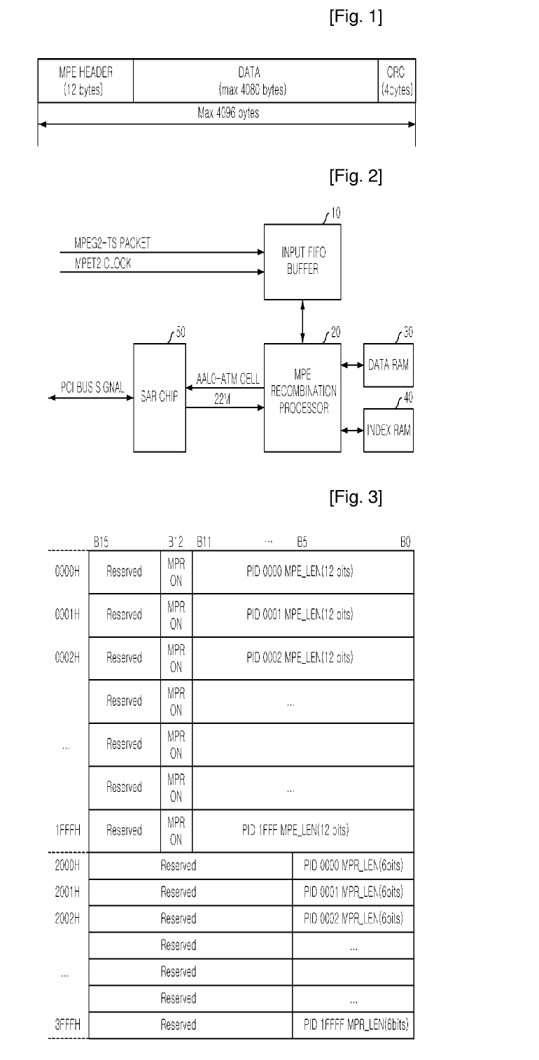

FIG. 1 shows a structure of a general multi-protocol encapsulation (MPE) packet.

The MPE packet is formed of a 12-byte header, a maximum of 4080-byte data, and 4-byte cyclic redundancy check (CRC).

In a bi-directional satellite multimedia system, many terminals partition multimedia data of an MPE format into Moving Picture Experts Group 2 (MPEG2) transport stream (TS) packets and transport the MPEG2 TS packets to a central station through a satellite link. A terminal transports the MPEG-2 TS packets to the central station based on a multi-frequency time division multiple access (MF-TDMA) method. The MPEG-2 TS packet is formed of a 4-byte header and 184-byte data.

The central station recombines the MPEG-2 TS packets transported from many terminals into the MPE packets and transports the MPE packets to host Central Processing Unit (CPU) through a peripheral component interconnect (PCI) bus.

FIG. 2 is a block diagram showing an apparatus for recombining MPE packets obtained by dividing data and transported in the form of Moving Picture Experts Group 2 (MPEG-2) Transport Stream (TS) packets in accordance with an embodiment of the present invention.

The MPE packet recombination apparatus of the present invention includes an input first-in first-out (FIFO) buffer 10, an MPE recombination processor 20, a data Random Access Memory (RAM) 30, an index RAM 40, and a segmentation and reassemble (SAR) chip 50.

The FIFO buffer 10 temporally buffers the MPEG-2 TS packet inputted from a modulator.

The MPE recombination processor 20 reads the MPEG-2 TS packet buffered in the input FIFO buffer 10 and recombines many MPE packets coupled with a data RAM 30 and an index RAM 40.

The data RAM 30 has a size of K×48-bytes. The data RAM 30 temporally stores data of less than 40 byte generated in a procedure of reading 184-byte data of K MPEG-2 TS packets having different packet identifiers (PID), wherein K is a natural number, by the MPE recombination processor 20, forming and outputting the 184-byte data into a 53-byte asynchronous transfer mode (ATM) adaptive layer 0 (AAL0-ATM) cell.

The index RAM 40 has a K×2-byte size, updates and stores MPE length information on a basis of an MPEG-2 TS packet unit by the MPE recombination processor.

The SAR chip 50 buffers Ethernet frame transported in the form of an AAL0-ATM cell created by the MPE recombination processor 20, and transport the Ethernet frame to the host CPU through a PCI bus when a complete MPE packet is buffered.

The input FIFO buffer 10 buffers a 188-byte MPEG-2 TS packet transported from many terminals. When at least one MPEG-2 TS packet is buffered in the input FIFO buffer 10, IF_RDY, which is an input FIFO data ready signal, is activated.

The MPE recombination processor 20 reads a header of the MPEG-2 TS packet, which is buffered by the input FIFO buffer 10, through the input FIFO data ready signal, decodes the header and checks a packet identifier (PID) of the header. The MPE recombination processor 20 can identify a transmission terminal through the PID. The packet identifier maintains the same value with respect to the same terminal while call setup is maintained.

The MPE recombination processor 20 checks a payload unit start indicator (PUSI) of the decoded header. When the PUSI is “1”, it means a first MPEG-2 TS packet. Accordingly, the MPE recombination processor 20 extracts 12-byte MPE length information included in the header, stores and updates 12-byte MPE length information in the address of the index RAM 40.

The memory address of the index RAM 40 is allotted identically with the packet identifier and a memory space corresponding to the PID number of 2̂13=8192 is allotted. Since the address of the index RAM 40 is the PID in the present invention, the process time can be reduced. Also, the MPE length information is required for transforming the randomly transmitted MPEG-2 TS packets of N numbers into the MPE packets. The MPE length information stored in the index RAM 40 is reset since the MPE length reduced as much as 48-byte, i.e., the payload length of an AAL0-ATM cell, whenever the AAL0-ATM cell is formed and outputted.

A memory address value of the index RAM 40 recording MPE_LEN, which is many MPE length information of each PID, and MPR_LEN, which is residue data length information, is determined by a following method.

MPE_LEN address of PID-N=PID

MPR_LEN address of PID-N=PID+2000H

An MPEG-2 TS packet has a 184-byte data size. When a 184-byte MPEG-2 TS packet is transformed into a 53-byte AAL0-ATM cell, i.e., 5-byte header+48-byte data, 3 cells of 48×3=144 can be completely reorganized as the AAL0-ATM cell. However, data organized in a 4^{th} cell have a size of 40 bytes subtracting 144 bytes from 184 bytes and cannot organize a complete AAL0-ATM cell. The 40-byte residue data can be organized and outputted as a complete 48-byte AAL0-ATM cell when the MPEG-2 TS packet having the identical PID is stored in the input FIFO buffer.

The data RAM 30 is prepared for storing a maximum of 40-byte residue data. That is, the data RAM 30 is controlled by the MPE recombination processor 20, temporally stores the residue data, which are not organized as the complete AAL0-ATM cell by the MPE recombination processor, and is outputted when other MPEG-2 TS packet having the identical packet identifier in the MPE recombination processor 20 is processed.

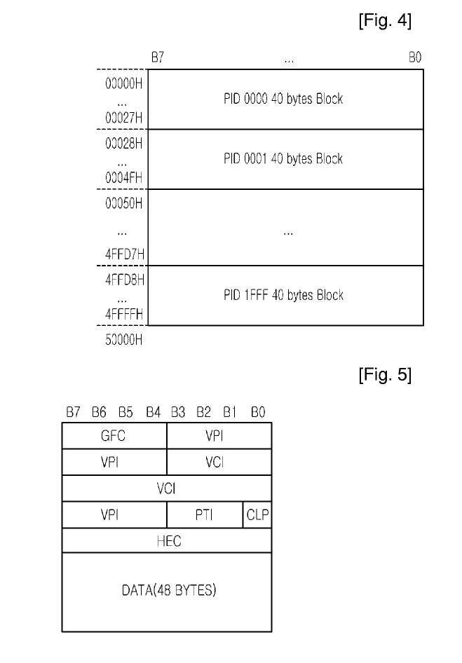

FIG. 4 shows a memory structure of the data RAM 30 for storing the residue data and a memory address is allotted as much as the number of PID, which is 2̂13=8192, on a basis of 40-byte block unit.

A maximum quantity of the residue data for organizing the AAL0-ATM cell is not larger than 40 bytes. A memory start address value of each block is determined by a following method.

MPR_LEN address of PID-N=PID+40×N

Rest data length information, i.e., MPR_LEN, and a residue data existence flag, i.e., MPR_ON, are recorded in the index RAM 40 to process the residue data. When an MPEG-2 Trans packet is buffered in the input FIFO buffer 10, the MPE recombination processor 20 reads the residue data existence flag and the residue data length information in the index RAM 40 by setting the PID as a key and checks whether the residue data exist. When the residue data exist, the MPE recombination processor 20 reads the residue data stored in the data RAM 30 by setting the PID as a key and organizes the AAL0-ATM cell.

The MPE recombination processor 20 creates and inserts a 5-byte header, reads the data stored in the input FIFO buffer 10 on a basis of 48-byte unit and outputs the data as the SAR chip 50. When the AAL0-ATM cell is transported to the SAR chip 50, interface timing follows a Utopia Level-1 standard.

When a packet is read in the input FIFO buffer 10, a case that the MPE length information does not correspond to the length of the MPEG-2 TS packet, i.e., N×188, may be generated. However, since the MPE recombination processor 20 decodes header information of the MPEG-2 TS packet inputted from the input FIFO buffer 10 on a basis of a byte unit, detects a synchronization byte of the header, which is 0x47, to process an operation on a basis of a packet unit, and is operated by being synchronized with the timing of the synchronization byte, it does not bring any problem.

FIG. 5 shows a structure of the 53-byte AAL0-ATM cell for transmitting data between the MPE recombination processor and the SAR chip. FIG. 5 shows a structure of a well-known ATM cell.

The MPE recombination processor 20 substitutes a 16-bit virtual channel identifier (VCI) of the AAL0-ATM cell header, which is outputted as the SAR chip 50 to process a maximum of 8192 MPE recombinations, into a PID value. The SAR chip 50 buffers each of the MPE packets transmitted to each terminal based on the VCI value and transports the MPE packets to the host CPU through the PCI bus.

A first AAL0-ATM cell and a last AAL0-ATM cell are transported based on a bit 0 among 3-bit payload type identifiers (PTIs) of the header. When the bit 0 of the PTI is “0”, it means a start cell. When the bit 0 of the PTI is “1”, it means a last cell.

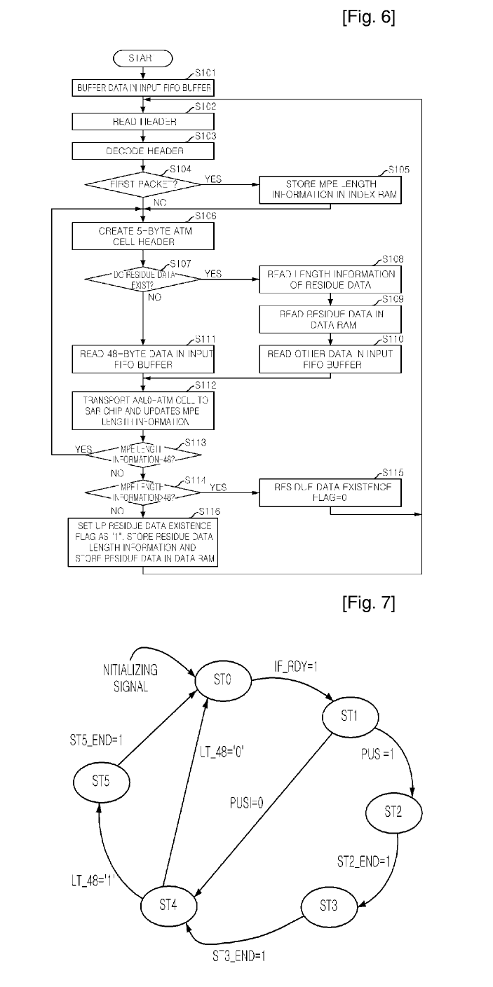

FIG. 6 is a flowchart describing a method for recombining MPE packets obtained by dividing data and transported in the form of MPEG2 TS packets in accordance with an embodiment of the present invention.

FIG. 7 shows state shift of an MPE recombination processor in accordance with an embodiment of the present invention.

When 188 bytes transported from a plurality of terminals, which are 4-byte header+184-byte data, are buffered in at least one input FIFO buffer at step S101, IF_RDY, which is an input FIFO data ready signal, is activated.

The MPE recombination processor 20 reads and decodes a header of the buffered MPEG-2 TS packet at steps S102 and S103. The MPE recombination processor 20 checks the PID by decoding the header and checks whether it is a first MPEG-2 TS packet by checking the PUSI information at step S104.

When it is the first MPEG-2 TS packet, the MPE recombination processor 20 extracts 12-byte MPE length information included in the header, and stores the length information in the address of the index RAM 40 having the value identical with the PID at step S105.

The MPE recombination processor 20 creates a 5-byte ATM cell header with the PID inserted into the virtual channel identifier (VCI) at step S106.

The MPE recombination processor 20 checks the residue data existence flag stored in the address of the index RAM 40 by setting the packet identifier as a key, and checks at step S107 whether the residue data having the PID exist.

When the residue data exist, the MPE recombination processor 20 extracts length information of the residue data from the address of the index RAM 40 at step S108 and reads the residue data in the address corresponding to the PID of the data RAM at step S109. The MPE recombination processor 20 reads other data that the read residue data are subtracted from 48 bytes in the input FIFO buffer at step S110. That is, when the length of the residue data is 40 bytes, the MPE recombination processor 20 reads only 8-byte data in the input FIFO buffer, combines data and a header of 48 bytes and creates an AAL0-ATM cell. The MPE recombination processor transports the AAL0-ATM cell created by the above process to the SAR chip and updates the MPE length information stored in an index RAM at step S112. That is, the MPE recombination processor 20 updates the MPE length information by subtracting the number of data byte read in the input FIFO buffer from the currently stored MPE length information.

When it turns out that the residue data do not exist, i.e., when the residue data existence flag of the index RAM is set up as “0” at step S107, the MPE recombination processor reads 48-byte data in the input FIFO buffer at step S111 and creates the AAL0-ATM cell through combination with the header. The MPE recombination processor transports the created AAL0-ATM cell to the SAR chip and updates the MPE length information at step S112 by subtracting 48 from the MPE length information stored in the index RAM.

The MPE recombination processor 20 checks at step S113 whether the current MPE length information is smaller than or equal to 48. When the MPE length information is larger than 48, the step S106 of creating the ATM cell header is repeatedly performed.

When the current MPE length information smaller than or equal to 48 at step S113, the MPE recombination processor 20 checks at step S114 whether the MPE length information is “0”. When the MPE length information is “0”, the residue data existence flag stored in the index RAM is set up as “0” at step S115, and the above process is repeatedly performed with respect to new MPEG-2 TS stored in the input FIFO buffer. When the MPE length information is not “0” at step S114, a process of setting up the residue data existence flag as “1”, storing the residue data length information in the address of the index RAM and storing the residue data in the address of the data RAM is performed at step S116.

FIG. 7 shows state transfer for describing an operation of the MPE recombination processor.

A state of the MPE recombination processor is transferred to an ST0 state by an initializing signal, i.e., RST, which is an initializing signal. When at least one MPEG-2 TS packet is buffered in the input FIFO in the ST0 state, the state of the MPE recombination processor is transferred to an ST1 state by an activated IF_RDY signal.

A process for latching and decoding a header is operated in the ST1 state. When a PUSI value is “1”, i.e., a first packet, the state of the MPE recombination processor is transferred to an ST2 state and 12-byte MPE length information is stored in the index RAM. When the PUSI value is “0”, the state of the MPE recombination processor is transferred to an ST4 state. Accordingly, the data stored in the input FIFO are organized as a 53-byte AAL0-ATM cell and outputted as the SAR chip.

An operation of combining the MPE header information latched in the ST2 state and the data buffered in the input FIFO, organizing and outputting the 53-byte AAL0-ATM cell is performed in the ST3 state.

In the ST4 state, the data stored in the input FIFO are repeatedly organized and outputted as the 53-byte AAL0-ATM cell. When the residue data of less than 48 bytes exist, i.e., when LT_{—}48=1, the state of the MPE recombination processor is transferred to the ST5 state. When the residue data do not exist, the state of the MPE recombination processor is transferred to the ST0 state of LT_{—}48=0.

In the ST5 state, the residue data of less than 48 bytes are stored in the data RAM, combined with the continuously transmitted data, organized and outputted as the 53-byte AAL0-ATM cell.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

The present application contains subject matter related to Korean patent application Nos. 2005-0116130 and 2006-0048233 filed with the Korean Intellectual Property Office on Dec. 1, 2005, and May 29, 2006, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. An apparatus for recombining multi-protocol encapsulation (MPE) packets, comprising the steps of:
a buffering means for buffering inputted transport stream (TS) packets;
a first memory means for temporally storing residue data whose size is too small to form a cell buffered in the buffering means;
a second memory means for storing a residue data existence flag and length information of data currently buffered in the buffering means;
a MPE recombination process means for analyzing header information of a buffered TS packet, storing the length information of an MPE packet in the second memory means, creating an asynchronous transfer mode (ATM) cell header, reading packet data from the buffering means, creating and outputting an ATM adaptive layer 0 (AAL0-ATM) cell as the created ATM cell header and the read packet data, updating the length information of the data buffered in the buffering means and stored in the second memory means by reducing the length information by a length of the data read in the buffering means, reading the residue data stored in the first memory means in case that the residue data existence flag is set up with respect to a packet having the same packet identifier (PID), reading insufficient data in the buffering means and creating an AAL0-ATM cell; and
a segmentation and reassemble (SAR) processing means for buffering the AAL0-ATM cell transported from the MPE recombination process means based on each PID, and transporting the AAL0-ATM cell to a host Central Processing Unit (CPU).

2. The apparatus as recited in claim 1, wherein when a memory address is allotted identically with the PID, the first memory means stores the residue data in a memory address corresponding to the packet identifier.

3. The apparatus as recited in claim 2, wherein when the memory address is allotted by including the PID, the second memory means stores the residue data existence flag, length information of the data currently buffered in the buffering means and length information of the residue data stored in the first memory means correspondingly to the packet identifier.

4. The apparatus as recited in claim 1, wherein the MPE recombination process means decodes a header of the TS packet buffered in the buffering means, checks the PID of the buffered packet and a payload unit start indicator (PUSI), and stores the length information of the packet in a memory address corresponding to the packet identifier of the second memory means by the PUSI in case of a first packet.

5. The apparatus as recited in claim 4, wherein when the length information of the data stored in the second memory means and currently buffered in the buffering means is a value which is not proper to organize a cell, the MPE recombination process means sets up the residue data existence flag stored in the second memory means correspondingly to the packet identifier, simultaneously stores the length information of the residue data stored in the first memory means in the second memory means, reads the residue data having a size which is not proper to organize a cell buffered in the buffering means and stores the residue data in the memory address corresponding to the PID of the first memory means.

6. The apparatus as recited in claim 1, wherein the MPE recombination process means inserts the PID information into a virtual channel identifier (VCI) of the AAL0-ATM cell header and organizes the header.

7. A method for recombining multi-protocol encapsulation (MPE) packets, comprising the steps of:
a) when at least one transport stream (TS) packet is buffered, reading header information of the buffered TS packet;
b) checking a packet identifier (PID) and a payload unit start indicator (PUSI) in the header information, and storing data length information of the currently buffered TS packet when a first packet is identified by the PUSI;
c) creating an asynchronous transfer mode (ATM) cell header and checking whether residue data corresponding to the PID exist;
d) when the residue data do not exist in the step c), reading data of the buffered TS packet, creating an ATM adaptive layer 0 (AAL0-ATM) cell by being integrated with the created header, transporting the AAL0-ATM cell to a segmentation and reassemble (SAR) chip and simultaneously updating data length information of the currently buffered TS packet;
e) when the residue data exist in the step c), reading the pre-stored residue data correspondingly to the PID, reading the data of the buffered TS packet as much as data insufficient for organizing a cell, creating the AAL0-ATM cell by being integrated with the created header, transporting the AAL0-ATM cell to the SAR chip and simultaneously updating the data length information of the currently buffered TS packet; and
f) when the data length information of the currently buffered TS packet has a value which is not proper to organize a cell, setting up the residue data existence flag correspondingly to the PID and temporally storing the residue data length information and the buffered residue data at the same time.

8. The method as recited in claim 7, wherein the header is created in step c) by inserting the PID information into a virtual channel identifier (VCI) of the AAL0-ATM cell header.
